(19) United States
(12) Patent Application Publication
(10) Pub. No.: US 2019/0385170 A1
(43) Pub. Date: Dec. 19, 2019

(54) Automatically-Updating Fraud Detection System

(71) Applicant: American Express Travel Related Services Company, Inc., New York, NY (US)

(72) Inventors: Apoorv Reddy Arrabothu, Bangalore (IN); Jayatu Sen Chaudhury, Gurgaon (IN); Prodip Hore, Kolkata (IN); Avinash Tripathy, Gurgaon (IN); Di Xu, Warren, NJ (US)

(73) Assignee: American Express Travel Related Services Company, Inc., New York, NY (US)

(21) Appl. No.: 16/012,258

(22) Filed: Jun. 19, 2018

(51) Int. Cl. G06Q 20/40; G06N 3/08

(52) U.S. Cl. CPC G06Q 20/4016; G06N 3/08

(57) ABSTRACT

The system may be configured to perform operations including receiving a transaction authorization request comprising transaction details; inputting the transaction details into a fraud scoring system comprising a fixed fraud detection model; inputting the transaction details into a neural network comprising an improvable fraud detection model; applying the fixed fraud detection model and the improvable fraud detection model to the transaction details; producing a fraud score in response to applying the fixed fraud detection model to the transaction details and a neural network fraud score in response to applying the improvable fraud detection model to the transaction details; analyzing the fraud score and the neural network fraud score; and/or sending an authorization response in response to analyzing the fraud score and the neural network fraud score.

### FIELD

The present disclosure generally relates to fraud detection for transactions, and more specifically, to an automatically-updating fraud detection system configured to aid in fraud detection.

### BACKGROUND

Transaction account issuers attempt to identify and reject fraudulent authorization requests in order to reduce fraud. Traditionally, a merchant submits an authorization request to the transaction account issuer to complete a transaction. The authorization request typically contains transaction information about the transaction, such as the transaction account of a consumer (e.g., an account identifier) and the merchant (e.g., a merchant identifier), etc.

To detect fraud, transaction account issuers may create fraud detection models used for fraud detection based on the transaction history and/or transaction pattern of, for example, various consumers and merchants, and/or consumer types and merchant types. The fraud detection models may be used to predict whether a transaction is fraudulent in response to an authorization request for a transaction being received from a merchant. The technical problem is that the fraud detection models must be updated periodically to maintain and/or increase their fraud detection effectiveness, and/or to reflect new transaction information received by the transaction account issuers. Updating the fraud detection models may be completed manually, which may be an onerous process. Another technical problem is that some fraud detection models may be fixed once the parameters of a fraud detection model are tuned to a desirable level, which precludes the models and parameters therein to be adjusted based on newly gathered data (i.e., new transaction information). Therefore, to utilize new transaction information to create an updated fraud detection model, the fraud detection model may have to be recreated from scratch, starting over and basing the updated fraud detection model on the previous and new transaction information. As such, with updating fraud detection models being traditionally difficult and/or time-consuming, the fraud detection models may not be updated as often as would be optimal to create the most effective fraud detection models reflecting the most current transaction history received by the transaction account issuers. An additional technical problem is that the fraud detection model may fail or become inaccurate, and there may be no other fraud detection score (or the like) with which to compare the output of the fraud detection model to gauge the accuracy.

### SUMMARY

A system, method, and article of manufacture (collectively, “the system”) are disclosed relating to an automatically-updating fraud detection model. In various embodiments, the system may be configured to perform operations including receiving, by a processor, a transaction authorization request for a transaction comprising transaction details; inputting, by the processor, the transaction details into a fraud scoring system comprising a fixed fraud detection model; inputting, by the processor, the transaction details into a neural network comprising an improvable fraud detection model; applying, by the processor and via the fraud scoring system, the fixed fraud detection model to the transaction details; producing, by the processor and via the fraud scoring system, a fraud score in response to applying the fixed fraud detection model to the transaction details; applying, by the processor and via the neural network, the improvable fraud detection model to the transaction details; producing, by the processor and via the neural network, a neural network fraud score in response to applying the improvable fraud detection model to the transaction details; analyzing, by the processor, the fraud score and the neural network fraud score; and/or sending, by the processor, an authorization response in response to the analyzing the fraud score and the neural network fraud score. In various embodiments, analyzing the fraud score and the neural network fraud score may comprise combining, by the processor, the fraud score and the neural network fraud score to produce a fraud prediction score; and/or analyzing, by the processor, the fraud prediction score. In various embodiments, analyzing the fraud prediction score may comprise determining if the fraud prediction score is above a predetermined fraud detection score threshold. In response to the fraud prediction score being one of above or below the predetermined fraud detection score threshold, sending an authorization response may comprise denying, by the processor, the transaction request. In response to the fraud prediction score being one of below or above the predetermined fraud detection score threshold, sending an authorization response may comprise approving, by the processor, the transaction request.

In various embodiments, before receiving the transaction details or after sending the authorization response, the operations may further comprise updating, by the processor, the improvable fraud detection model. The neural network may utilize normalized adaptive gradient updates for to update the improvable fraud detection model. In various embodiments, updating improvable fraud detection model may comprise receiving, by the processor, new transaction information for a plurality of new transactions, wherein the plurality of new transactions comprises a plurality of new approved transactions comprising new approved transaction details and a plurality of new fraudulent transactions comprising new fraudulent transaction details; automatically inputting, by the processor, the new transaction information into the neural network; automatically inputting, by the processor, a plurality of desired neural network outputs into the neural network each associated with at least one new transaction of the plurality of new transactions; automatically applying, by the processor, the improvable fraud detection model of the neural network to each new transaction of the plurality of new transactions, producing, by the processor, a training neural network fraud score associated with each new transaction of the plurality of new transactions; comparing, by the processor, the training neural network fraud score associated with each new transaction of the plurality of new transactions with the desired neural network output of each respective new transaction of the plurality of new transactions; calculating, by the processor, a first calculated score difference between the training neural network fraud score and the desired neural network output in response to the comparing the training neural network fraud score with the desired neural network output; adjusting, by the processor, the improvable fraud detection model based on the first calculated score difference, producing, by the processor, an updated improvable fraud detection model; and/or replacing, by the processor, the improvable fraud detection model in the neural network with the updated improvable fraud detection model. In various embodiments, adjusting the improvable fraud detection model to produce the updated improvable fraud detection model may comprise adjusting a plurality of weighted parameters comprised in the improvable fraud detection model. In various embodiments, at least one of the plurality of new transactions may be associated with a transaction occurring during a time period before the receiving the new transaction information.

In various embodiments, combining the fraud score and the neural network fraud score may comprise converting, by the processor, the fraud score to a first probability by applying a probability mapping function to the fraud score; converting, by the processor, the neural network fraud score to a second probability by applying a probability mapping function to the neural network fraud score; and/or adding, by the processor, the first probability and the second probability together to produce the fraud prediction score. In various embodiments, adding the first probability and the second probability together may comprise applying, by the processor, a first probability weight to the first probability producing a first adjusted probability; applying, by the processor, a second probability weight to the second probability producing a second adjusted probability; and/or adding the first adjusted probability and the second adjusted probability together. In various embodiments, a sum of the first probability weight and the second probability weight may be 1.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 depicts an exemplary automatically-updating fraud detection system, in accordance with various embodiments;

FIG. 2 depicts an exemplary authorization system, in accordance with various embodiments;

FIG. 3 depicts an exemplary neural network, in accordance with various embodiments;

FIG. 4 depicts an exemplary method for authorizing a transaction, in accordance with various embodiments; and

FIG. 5 depict exemplary method for updating an improvable fraud detection model, in accordance with various embodiments.

### DETAILED DESCRIPTION

The detailed description of various embodiments makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

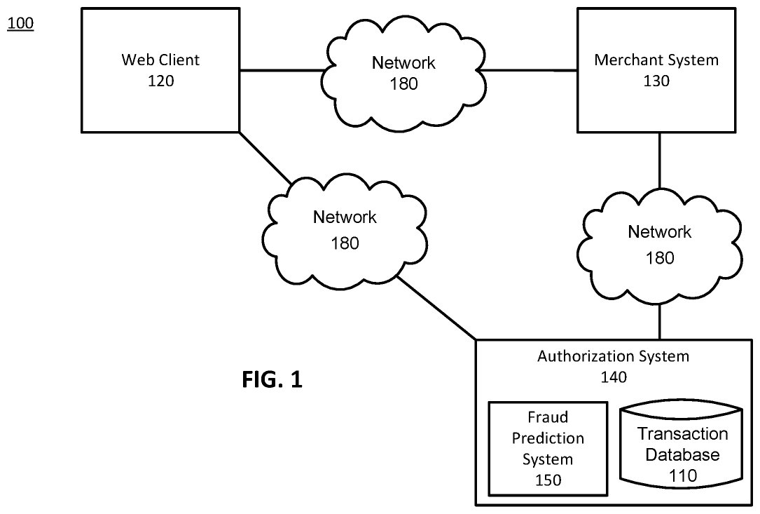

With reference to FIG. 1, an exemplary automatically-updating fraud detection system 100 is disclosed. In various embodiments, system 100 may comprise a web client 120, a merchant system 130, and/or an authorization system 140. All or any subset of components of system 100 may be in communication with one another via a network 180. System 100 may be computer-based, and may comprise a processor, a tangible non-transitory computer-readable memory, and/or a network interface. Instructions stored on the tangible non-transitory memory may allow system 100 to perform various functions, as described herein.

In various embodiments, web client 120 may incorporate hardware and/or software components. For example, web client 120 may comprise a server appliance running a suitable server operating system (e.g., MICROSOFT INTERNET INFORMATION SERVICES or, “IIS”). Web client 120 may be any device that allows a user to communicate with network 180 (e.g., a personal computer, personal digital assistant (e.g., IPHONE®, BLACKBERRY®), cellular phone, kiosk, and/or the like). Web client 120 may be in communication with merchant system 130 and/or authorization system 140 via network 180. Web client 120 may participate in any or all of the functions performed by merchant system 130 and/or authorization system 140 via network 180.

Web client 120 includes any device (e.g., personal computer) which communicates via any network, for example such as those discussed herein. In various embodiments, web client 120 may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with merchant system 130 via network 180 by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, the browser may be configured to display an electronic channel.

In various embodiments, network 180 may be an open network or a closed loop network. The open network may be a network that is accessible by various third parties. In this regard, the open network may be the internet, a typical transaction network, and/or the like. Network 180 may also be a closed network. In this regard, network 180 may be a closed loop network like the network operated by American Express. Moreover, the closed loop network may be configured with enhanced security and monitoring capability. For example, the closed network may be configured with tokenization, associated domain controls, and/or other enhanced security protocols. In this regard, network 180 may be configured to monitor users on network 180. In this regard, the closed loop network may be a secure network and may be an environment that can be monitored, having enhanced security features.

In various embodiments, merchant system 130 may be associated with a merchant, and may incorporate hardware and/or software components. For example, merchant system 130 may comprise a server appliance running a suitable server operating system (e.g., Microsoft Internet Information Services or, “IIS”). Merchant system 130 may be in communication with web client 120 and/or authorization system 140. In various embodiments, merchant system 130 may comprise a merchant identifier (MID) which is specific to the merchant. The MID may be a number, or any other suitable identifier, specific to the merchant that identifies the merchant in a transaction. In various embodiments, merchant system 130 may comprise an online store, which consumers may access through the browser on web client 120 to purchase goods or services from the merchant.

In various embodiments, authorization system 140 may be associated with a transaction account issuer, an entity that issues transaction accounts to customers (i.e., consumers) such as credit cards, bank accounts, etc. Authorization system 140 may comprise hardware and/or software capable of storing data and/or analyzing information. Authorization system 140 may comprise a server appliance running a suitable server operating system (e.g., MICROSOFT INTERNET INFORMATION SERVICES or, “IIS”) and having database software (e.g., ORACLE) installed thereon. Authorization system 140 may be in electronic communication with web client 120 and/or merchant system 130. In various embodiments, Authorization system 140 may comprise software and hardware capable of accepting, generating, receiving, processing, and/or analyzing information related to completing transactions and fraud detection.

In various embodiments, authorization system 140 may comprise a transaction database 110. Transaction database 110 may be configured to receive and store transaction information from transactions completed between at least two parties (e.g., merchants and consumers). The merchants involved in the transactions may be associated with the transaction account issuer that is associated with authorization system 140, and the consumers involved in the transactions may hold transaction accounts issued from the transaction account issuer that is associated with authorization system 140.

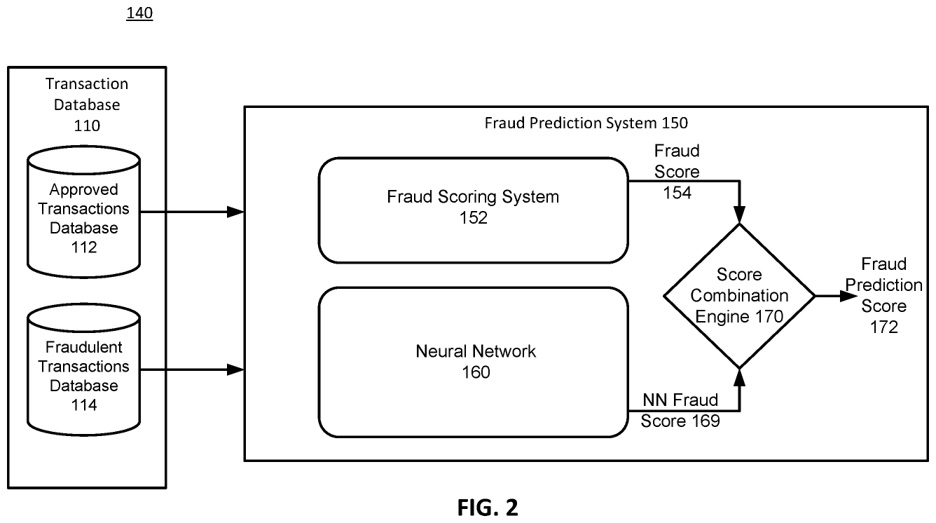

With reference to FIGS. 1 and 2, in various embodiments, transaction database 110 may comprise an approved transactions database 112 and a fraudulent transaction database 114. In various embodiments, approved transactions database 112 and/or fraudulent transaction database 114 may be discrete databases from each other and/or transaction database 110. Approved transactions database 12 may store previous transactions (and the associated information/details) between parties that were approved by authorization system 140. In other words, after processing by fraud prediction system 150, transactions that were determined not to be fraudulent, and were therefore approved, are stored in approved transaction database 112. Fraudulent transactions database 114 may store previous attempted transactions (and the associated information/details) between parties that were rejected because they were determined to be fraudulent (or likely to fraudulent) by fraud prediction system 150.

In various embodiments, authorization system 140 may comprise a fraud prediction system 150. Fraud prediction system 150 may be configured to receive an authorization request to complete a transaction from merchant system 130. The authorization request may comprise transaction information and/or details such as party identifiers (e.g., a merchant identifier (e.g., an MID), a consumer identifier (e.g., a transaction account identifier such as an account number, a consumer profile, etc.)), a transaction amount, date, time, location, item being purchase, or the like. Fraud prediction system 150 may analyze the transaction details in the authorization request in order to determine whether the associated transaction is (likely) fraudulent. Fraud prediction system 150, or any of the components comprised therein, may comprise a server appliance running a suitable server operating system (e.g., MICROSOFT INTERNET INFORMATION SERVICES or, “IIS”) and having database software (e.g., ORACLE) installed thereon.

In various embodiments, fraud prediction system 150 may comprise a fraud scoring system 152 and/or a neural network 160. Fraud scoring system 152 and/or neural network 160 may each apply a respective fraud detection model(s) to the transaction details associated with the authorization request (i.e., pass the transaction details through the fraud detection model(s)) to determine a score indicating whether, or the likelihood that, the associated transaction is fraudulent. Fraud detection models may be multidimensional variables (i.e., sequences of numbers or data, which create a vector) associated with consumers, merchant, types of consumers or merchants, and/or the like. The fraud detection models may reflect transaction patterns (e.g., associated with a type of consumer/merchant engaging in certain types of transactions at certain times occurring in certain frequencies, and at certain places of the associated consumer and/or merchant) such that fraud prediction system 150 may be able to detect if a transaction follows or matches such transaction patterns. If not, the transaction may be determined as fraudulent. Each fraud detection model may comprise parameters having different weights which are applied to the transaction details. In various embodiments, each fraud detection model may be configured to recognize a specific transaction detail associated with the transaction information, and analyze its association with and/or resemblance to a transaction pattern (i.e., whether the transaction detail fits or matches the appropriate transaction pattern).

In various embodiments, fraud scoring system 152 may comprise a fixed fraud detection model, having tuned parameters (e.g., decision trees), which is applied to the transaction details. The fixed fraud detection model may be any suitable fixed model, such as a gradient boosted machine (GBM), which may comprise an ensemble of multiple predictive models having, for example, decision trees. Additional information about GBM may be found in Greedy Function Approximation: A Gradient Boosting Machine by Jerome H. Friedman published by the Institute of Mathematical Statistics in The Annals of Statistics, Vol. 29, No. 5 (October, 2001), pp. 1189-1232, which is hereby incorporated by reference in its entirety. In various embodiments, the fixed fraud detection model may be trained by adjusting the parameters comprised therein to create the tuned parameters such that the fixed fraud detection model may accurately determine whether a transaction is fraudulent. Training the fixed fraud detection model may comprise inputting transaction details for transactions from a past duration, or transaction details for a fraction of the transactions (e.g., 2%) from the past duration. (e.g., from the past two years). A desired output(s) may be input into fraud scoring system 152, which may be the output which fraud scoring system 152 is desired to produce (e.g., indicating whether a transaction is fraudulent or not). A desired output may be input for each past transaction and associated set of transaction details. In various embodiments, the desired output may be a label and/or marker affixed or associated with the transaction information associated with the desired output. Therefore, to train the fixed fraud detection model, a transaction and associated transaction details may be input into fraud scoring system 152, and fraud scoring system 152 may apply the fixed fraud detection model (i.e., pass the transaction details through the fixed fraud detection model), producing a generated training fraud score (e.g., fraud score 154). The generated training fraud score may be produced by combining outputs (e.g., scores) from multiple predictive models (e.g., decision trees) of the fixed fraud detection model (each predictive model may create an output in response to analyzing the transaction details for a transaction). The generated training fraud score may be compared to the desired output associated with the input transaction, and a difference (e.g., an error) between the two may be calculated. The difference between the generated training fraud score and the desired output may be, in various embodiments, a single value difference or an absolute difference, a mean squared difference, or the like. In various embodiments, the difference may be a distribution difference between an output distribution of the generated training fraud score and a desired output distribution of desired outputs. The distribution difference may reflect the difference in the distribution of generated training fraud scores and desired outputs.

In response to calculating the difference between the generated training fraud score and the desired output, the parameters of the fixed fraud detection model may be adjusted to decrease the difference calculated (e.g., error) between a generated training fraud score and a desired output. In various embodiments, adjustment of the parameters may be the adjustment of parameter weights, or the adjustment of a decision tree(s) within the fixed fraud detection model. The parameters may be adjusted multiple times over multiple iterations of inputting a transaction and transaction details into fraud scoring system 152, inputting an associated desired output, applying the fixed fraud detection model with the parameters (which may have been adjusted from previous iterations), producing a generated training fraud score, comparing the generated training fraud score with the desired output, and adjusting the parameters to further decrease the difference in future iterations. The parameters of the fixed fraud detection model may be adjusted until all of the transactions have been input into and processed by fraud scoring system 152 and/or a desired difference between the generated training fraud scores and the desired outputs is achieved (i.e., a desired accuracy level). The desired accuracy level may be a level at which most (e.g., 95% or more) or all of the transactions are accurately determined by fraud scoring system 152 as fraudulent or not (i.e., most or all generated fraud scores match with, or have minimal difference from, the respective desired outputs).

In response to the accuracy level being achieved, the values of the parameters are fixed, such that the fixed fraud detection model and its parameters may not be adjusted. Therefore, the fixed fraud detection model and its parameters may not be updated with additional transaction information (e.g., transaction details) that are obtained after training the fixed fraud detection model.

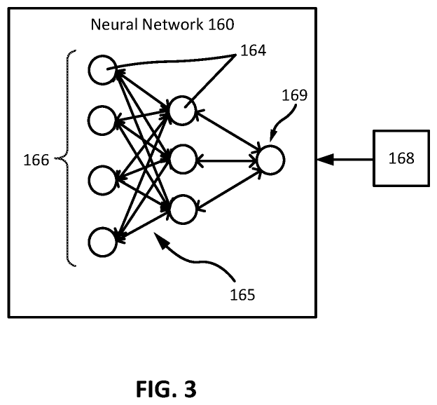

In various embodiments, with reference to FIGS. 2 and 3, neural network 160 may comprise nodes 164, which are processing elements that are connected to form neural network 160, and directed edges 165, which are signals sent between nodes 164. Neural Network may comprise a hidden processing layer of nodes 164. In various embodiments, neural network 160 may be a deep neural network comprising at least two hidden processing layers of nodes 164. Nodes 164 may denote an aggregator/summarizer operator (i.e., summation of incidental signals from directed edges 165). Directed edges 165 may each comprise a weight (i.e., a relative importance) associated with them configured to influence the way in which neural network 160 processes the information associated with each directed edge 165 between nodes 164. Nodes 64 and directed edges 165 may be part of an improvable fraud detection model comprised in neural network 160. In various embodiments, neural network 160 may be any suitable neural network, such as a neural network utilizing normalized adaptive gradient (NAG) updates to tune (i.e., improve the accuracy of) weights associated with directed edges 165. NAG updates may allow neural network 160 the ability to incrementally update the weights associated with directed edges 165 in real time. Additional information about neural networks utilizing normalized adaptive gradient updates may be found in Normalized Online Learning by Stéphane Ross, Paul Mineiro, and John Langford published by Cornell University Library, arXiv:1305.6646 (May 28, 2013), which is hereby incorporated by reference in its entirety. The improvable fraud detection model may be applied to transaction details input into neural network 160 for analysis as to whether the transaction associated with the transaction details is fraudulent.

In various embodiments, the improvable fraud detection model may be trainable and periodically updated to reflect newly obtained transaction information and patterns, therefore allowing fraud detection to remain accurate in light of new information. In various embodiments, the improvable fraud detection model may utilize the most recent version of the improvable fraud detection model, upon which to build and update the directed edges and weights associated therewith. For example, to first train the improvable fraud detection model, a starting point may be the parameter values (i.e., weights) of the tuned parameters in the fixed fraud detection model of fraud scoring system 152, and then updating the parameter values in light of new transaction information (i.e., transaction information obtained after training of the fixed fraud detection model) to create the improvable fraud detection model. As another example, to update the improvable fraud detection model, the improvable fraud detection model may begin from the most recent updated version of the improvable fraud detection model and further update the most recent updated version of the improvable fraud detection model in light of more recent transaction information.

With combined reference to FIGS. 2, 3, and 5, a method 500 for updating an improvable fraud detection model is depicted, in accordance with various embodiments. As discussed above, the improvable fraud detection model may begin with the latest directed edges/weights (i.e., the parameters) of neural network 160. Therefore, improving the accuracy of (i.e., updating) the improvable fraud detection model may comprise building off of the previous version of the improvable fraud detection model (which was based on previous transaction information) to detect fraudulent transactions, rather than starting over with new transaction information. Thus the improvable fraud detection model solves the problem in the prior art of having to start over from scratch to update (i.e., further adjust the parameters of) a fraud detection model, because a fixed fraud detection model cannot be simply updated or re-tuned by incorporating new transaction information (i.e., transaction information obtained after the tuning of the fraud detection model).

In various embodiments, transaction database 110 may receive new transaction information (step 502) associated with new transactions that were not used in a previous update of the improvable fraud detection model. The new transactions and new transaction information (e.g., provided in real time) may comprise new approved transactions comprising associated approved transaction details and new fraudulent transactions comprising associated fraudulent transaction details. The new transaction information may be shuffled such that the new approved transactions and associated details are intermixed with the new fraudulent transactions and associated details.

Therefore, neural network 160 may not determine whether transaction details indicate a fraudulent transaction simply by identifying patterns of new transactions in close proximity (e.g., close in time, location, etc.). In response to the new transaction information being received and/or a certain duration lapsing from the last update of the improvable fraud detection model, the new transaction information may be input into neural network 160 (step 504) from transaction database 110, which may occur automatically. The new transaction information input into neural network 160 may be inputs 166 depicted in FIG. 3. The new transaction information may be transaction information obtained after the last update of the improvable fraud detection model. The new transaction information may comprise a portion of the approved transactions (e.g., under 10%), and all or a portion of the fraudulent transactions, which will be used to update the improvable fraud detection model.

In various embodiments, transaction database 110 may comprise a desired neural network output 168 associated with each (new) transaction and the associated transaction information/details. Desired neural network output 168 may be the output of neural network 160 desired in response to applying the improvable fraud detection model to the respective transaction information associated with desired neural network output 168. Therefore, a desired neural network output(s) 168 associated with the each new transaction may be input into neural network 160 (step 506). The desired output may be an indicator of whether the associated transaction is fraudulent or not, and therefore, indicates the desired fraud score (i.e., output) of neural network 160. In various embodiments, the desired neural network output 168 associated with a transaction may be input into neural network as an attachment to the associated transaction information or as a marker comprised in the associated information. Neural network 160 may apply the improvable fraud detection model to the new transaction information (step 506) (i.e., to transaction details associated with one or more new transactions), or in other words, neural network 160 may pass the new transaction information through the improvable fraud detection model, producing a training neural network fraud score (e.g., neural network (NN) fraud score 169, which is the output of neural network 160). A training neural network fraud score may be produced in association with every new transaction to which the improvable fraud detection model is applied. The training neural network fraud score associated with a new transaction may be compared to the desired neural network output 168 associated with the same new transaction (step 510), and a difference (e.g., an error) between the two may be calculated (step 512). The difference (i.e., the error) between the training neural network fraud score and the desired output may be, in various embodiments, a single value difference or an absolute difference, a mean squared difference, or the like. In various embodiments, the difference may be a distribution difference between an output distribution difference of the training neural network fraud scores and a desired output distribution of desired neural network outputs 168. The distribution difference may reflect the difference in the distribution of training neural network fraud scores and desired neural network outputs.

Neural network 160 may update the improvable fraud detection model by adjusting the weights associated with one or more directed edges 165 (i.e., weighted parameters) to influence the processing of information between nodes 164 within neural network 160. Such an adjustment of directed edges 165 is aimed to more accurately analyze inputs into neural network 160 (i.e., new transactions) in order to produce outputs (neural network fraud scores) more closely resembling desired neural network outputs. Adjustment of weights may be performed through a standard back-propagation algorithm, for example, by the method in Learning representations by back-propagating errors, David E. Rumelhard, Geoffrey E. Hinton, and Ronald J. Williams, 323 NATURE, 533-36 (8 Oct. 1986), which is incorporated herein by reference in its entirety. Therefore, in response to calculating the difference between the training neural network fraud score and desired neural network output 168 for each new transaction, fraud prediction system 150 and/or neural network 160 may adjust the weighted parameters of the improvable fraud detection model (step 514) to decrease the difference calculated between a training neural network fraud score and a desired neural network output 168 for the same new transaction. The weighted parameters may be adjusted multiple times over multiple iterations of inputting a new transaction and transaction details into neural network 160, inputting an associated desired neural network output, applying the improvable fraud detection model with the parameters (which may have been adjusted from previous iterations), producing a training neural network fraud score, comparing the training neural network fraud score with desired neural network output 168, and adjusting the parameters of the improvable fraud detection model to further decrease the difference in future iterations. The parameters of the improvable fraud detection model may be adjusted until a desired number of transactions and associated transaction information have been input into and processed by neural network 160 and/or a desired difference between the training fraud neural network scores and the desired neural network outputs 168 is achieved (i.e., a desired accuracy level). The desired accuracy level may be a level at which most (e.g., 95% or more) or all of the transactions are accurately determined by neural network 160 as fraudulent or not (i.e., most or all generated fraud scores match with, or have minimal difference from, the respective desired outputs).

In response to the desired accuracy level being achieved, the parameter values of the updated improvable fraud detection model may be saved in fraud prediction system 150. The previous improvable fraud detection model utilized by neural network 160 before updating with new transaction information may be replaced by the updated improvable fraud detection model (step 516). Therefore, in predicting fraud for incoming transaction authorization requests, neural network 160 may use the updated improvable fraud detection model.

In various embodiments, any combination of steps 502-516 may occur automatically, continuously, and/or repeatedly, such that the improvable fraud detection model associated with neural network 160 are continuously updated. The resulting updated improvable fraud detection models will be more effective at detecting fraud in response to receiving an authorization request for a transaction from a merchant.

Updating the improvable fraud detection model may occur at any desired interval of time (e.g., daily, weekly, etc.). Therefore, for example, every week, neural network 160 may receive the newly obtained transaction information, i.e., transaction information not used in the most recent update of the improvable fraud detection model (e.g., comprising new transactions including new approved transaction details and new fraudulent transaction details) and update the improvable fraud detection model as described in relation to method 500. In various embodiments, neural network 160 may be configured to receive and/or process new transaction information to update the improvable fraud detection model in real time (i.e., updating every time new transaction information is received by authorization system 150, or in short intervals (e.g., minutes or hours)).

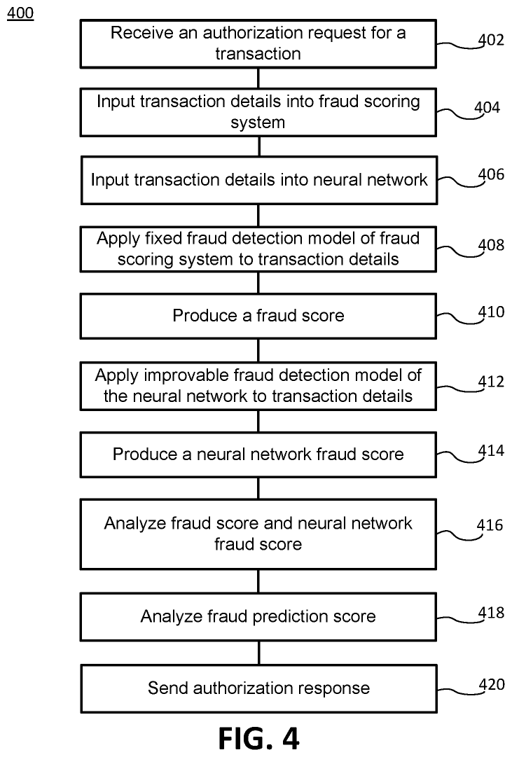

In various embodiments, utilizing fraud prediction system 150 comprising fraud scoring system 152, with its fixed fraud detection model, and neural network 160, with its improvable fraud detection model (the latest updated version), authorization system 140 may determine whether a transaction is fraudulent and authorize or reject the transaction. Accordingly, with combined reference to FIGS. 1-2 and 4, a method 400 for authorizing a transaction is depicted. In various embodiments, to complete a transaction between two parties (e.g., a consumer and a merchant), the merchant (via merchant system 130) may send a transaction authorization request to authorization system 140 comprising transaction details associated with the transaction. Authorization system 140 may receive the authorization request (step 402) and input the transaction details into fraud scoring system 152 (step 404) for analysis. Authorization system 140 may also input the transaction details into neural network 160 (step 406) for analysis. Fraud scoring system 152 may apply the fixed fraud detection model having tuned parameters (which are determined as described herein) to the transaction details (step 408) to produce a fraud score 154 (step 410). Applying the fixed fraud detection model to the transaction details may comprise passing the transaction models through the tuned parameters (e.g., decision trees), wherein each decision tree creates a score, and the scores from all multiple decision trees are combined by fraud scoring system 152 to produce fraud score 154. Fraud score 154 may be a value (e.g., a score in the range of zero to one, indicating the likelihood of fraud), a binary determination (e.g., indicating a fraudulent or legitimate transaction), or the like, indicating whether the transaction details belong to a fraudulent transaction. Similarly, neural network 160 may apply the improvable fraud detection model having weighted parameters (which may be the most recently updated, as described herein) to the transaction details (step 412) to produce a neural network (NN) fraud score 169 (step 414). NN fraud score 169 may be a value (e.g., a score in the range of zero to one, indicating the likelihood of fraud), a binary determination (e.g., indicating a fraudulent or legitimate transaction), or the like, indicating whether the transaction details belong to a fraudulent transaction.

In various embodiments, fraud prediction system 150 may analyze fraud score 154 and/or NN fraud score 169 (step 416). In various embodiments, fraud prediction system 150 may analyze fraud score 154 and/or NN fraud score 169 to determine their accuracy, and/or the accuracy of fraud scoring system 152 and/or neural network 160. For example, if fraud score 154 and/or NN fraud score 169 produces a score that is outside of a usual or useful range of scores, fraud prediction system 150 may determine that fraud scoring system 152 and/or neural network 160 are not functioning properly, or require updating or replacing. In various embodiments, fraud prediction system 150 may disable fraud scoring system 152 and/or neural network 160 in response to a detected malfunction or inaccuracy. For example, in response to an error detected in neural network 160, fraud prediction system 150 may disable neural network 160 for the transaction authorization process, utilizing only fraud scoring system 152 for authorizing transactions. In various embodiments, fraud prediction system 150 may analyze fraud score 154 and/or NN fraud score 169 separately. There may be a predetermined fraud score threshold (or range) for fraud score 154 and/or NN fraud score 169, and if fraud score 154 and/or NN fraud score 169 is at or above (or outside of) such a fraud score threshold (or range), fraud prediction system 150 may determine that a transaction is fraudulent. If fraud score 154 and/or NN fraud score 169 is at or below (or within) the fraud score threshold (or range) the transaction is legitimate. Such a scale for fraud determination may comprise any suitable configuration, for example, a fraud score below (or within) a threshold (or range) may indicate fraud. In various embodiments, fraud prediction system 150 may analyze fraud score 154 and/or NN fraud score 169 as a confirmation of the accuracy of the other score. For example, if fraud score 154 is within an acceptable score range to authorize a transaction, but NN fraud score 169 is outside of the acceptable score range, fraud prediction score 150 may detect a discrepancy between fraud score 154 and NN fraud score 169, and reject the transaction in response. Accordingly, the duplicity of having fraud score 154 from fraud scoring system 152 and NN fraud score 169 from neural network 160 may address the problem in the prior art of possible inaccuracies in a fraud detection model (e.g., the fixed fraud detection model and/or the improvable fraud detection model), by allowing the combining of fraud scores to make a fraud prediction, and/or the comparing of fraud score 154 and NN fraud score 169 to confirm accuracy of one or both and/or to confirm the proper functioning of fraud scoring system 152 and neural network 160.

In various embodiments, to utilize the analysis of both fraud scoring system 152 and neural network 160, authorization system 170 may comprise a score combination engine 170. In various embodiments, as part of analyzing fraud score 154 and/or NN fraud score 169, score combination engine 170 may combine fraud score 154 and NN fraud score 169 to produce a fraud prediction score 172. In various embodiments, combining fraud score 154 and NN fraud score 169 may comprise converting fraud score 154 and NN fraud score 169 each to a probability value, reflecting the probability that the subject transaction is (or is not) fraudulent. Converting fraud score 154 to a first probability value may comprise applying a first probability mapping function to fraud score 154. For example, the first probability mapping function may be a linear mapping between values of fraud score 154 and the corresponding first probability value. Converting NN fraud score 169 to a second probability value may comprise applying a second probability mapping function to NN fraud score 169. The second probability mapping function may be a linear mapping between values of NN fraud score 169 and the corresponding second probability value.

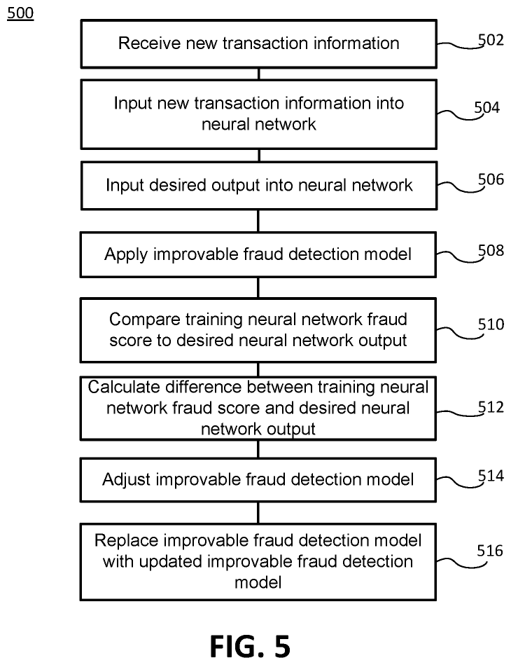

In various embodiments, combining fraud score 154 and NN fraud score 169 may further or alternatively comprise adding fraud score 154 and NN fraud score 169 (or their respective probability values) together. In various embodiments, adding fraud score 154 and NN fraud score 169 may comprise simply adding their raw values or respective probability values. In various embodiments, adding fraud score 154 and NN fraud score 169 (or their respective probability values) may comprise applying a probability weight to each. For example, a first probability weight may be applied to fraud score 154 and a second probability weight may be applied NN fraud score 169. The probability weights may represent the weight given to the respective value (e.g., indicating the respective relevance of fraud score 154 and NN fraud score 169). For example, if neural network 160 was created recently before processing a transaction, or only been updated (such as by method 500 discussed in relation to FIG. 5) a few times, fraud score 154 produced by fraud scoring system 152 may be weighted more than NN fraud score 169 because the fixed fraud detection model in fraud scoring system 152 was trained on more transaction information than neural network 160. As the improvable fraud detection model of neural network 160 is continually updated and improved, NN fraud score 169 may be weighted increasingly more relative to fraud score 154. Therefore, a first probability weight may be applied to fraud score 154 (or the first probability value produced therefrom) producing a first adjusted probability, and a second probability weight may be applied to NN fraud score 169 (or the second probability value produced therefrom) producing a second adjusted probability. In various embodiments, a sum of the first probability weight and the second probability weight may be equal to a value of one.

In various embodiments, fraud prediction system 150 may analyze fraud prediction score 172 (step 418) to determine if the subject transaction is fraudulent. There may be a predetermined fraud prediction score threshold (or range), at or above (or outside of) which fraud prediction system 150 may determine that a transaction is fraudulent, and/or at or below (or within) which the transaction is legitimate, or vice versa. Such a scale for fraud determination may comprise any suitable configuration. For example, fraud prediction system 150 may determine that a transaction is fraudulent if fraud prediction score 172 is at or below (or at or above) a predetermined fraud prediction score threshold (or outside or inside a fraud prediction score range), and/or that a transaction is legitimate if fraud prediction score 172 is at or above (or at or below) the predetermined fraud prediction score threshold (or within a fraud prediction score range). Or, the scales may be reversed such that fraud prediction system 150 may determine that a transaction is legitimate if fraud prediction score 172 is at or below (or at or above) a predetermined fraud prediction score threshold (or outside or inside a fraud prediction score range), and/or that a transaction is fraudulent if fraud prediction score 172 is at or above (or at or below) the predetermined fraud prediction score threshold (or within a fraud prediction score range).

In response to analyzing fraud score 154, NN fraud score 169, and/or fraud prediction score 172, authorization system 140 may send an authorization response (step 420). In response to fraud score 154, NN fraud score 169, and/or fraud prediction score 172 being at or above the predetermined fraud prediction score threshold (or otherwise indicating to fraud prediction system 150 that the transaction is fraudulent), fraud prediction system 150 may determine that the transaction is fraudulent, and send an authorization response to merchant system 130 rejecting the transaction. In response to fraud score 154, NN fraud score 169, and/or fraud prediction score 172 being at or below the predetermined fraud prediction score threshold (or otherwise indicating to fraud prediction system 150 that the transaction is legitimate), fraud prediction system 150 may determine that the transaction is legitimate, and send an authorization response to merchant system 130 approving the transaction.

In various embodiments, fraud prediction system 150 and/or neural network 160 may be configured such that the learning rate of neural network 160 does not decay below a certain point (i.e., never reach zero). Fraud prediction system 150 and/or neural network 160 may set a minimum learning rate at a level above zero. Therefore, neural network 160 may not stop learning (i.e., may not stop improving and updating improvable fraud detection model), such that neural network 160 and fraud prediction system 150 continually improves its accuracy of determining whether a transaction is fraudulent.

The systems and methods discussed herein improve the functioning of the computer. For example, by including neural network 160 into fraud prediction system 150, the accuracy of authorization system 140 and/or fraud prediction system 150 in detecting and preventing fraud may continually increase by updating fraud detection models with the most recent transaction data (e.g., real time data). Fraudulent trends in recent (i.e., new) transaction information may be detected and used to update the improvable fraud detection model, and the cessation of such a fraudulent trend may also be detected, and the improvable fraud detection model may be updated accordingly. Also, the relative weight given to fraud scores from fraud scoring system 152 and neural network 160 allows fraud prediction system 150 to determine the accuracy of each of fraud scoring system 152 and neural network 160 and apply the appropriate weight to the respective analysis results. Additionally, if one (or both) of fraud scoring system 152 or neural network 160 is malfunctioning or inaccurate, the problematic system may be disabled to prevent inaccurate fraud determinations.

The disclosure and claims do not describe only a particular outcome of fraud determination, but the disclosure and claims include specific rules for implementing the outcome of fraud determination and that render information into a specific format that is then used and applied to create the desired results of fraud determination, as set forth in McRO, Inc. v. Bandai Namco Games America Inc. (Fed. Cir. case number 15-1080, Sep. 13, 2016). In other words, the outcome of fraud determination can be performed by many different types of rules and combinations of rules, and this disclosure includes various embodiments with specific rules. While the absence of complete preemption may not guarantee that a claim is eligible, the disclosure does not sufficiently preempt the field of fraud determination at all. The disclosure acts to narrow, confine, and otherwise tie down the disclosure so as not to cover the general abstract idea of just fraud determination. Significantly, other systems and methods exist for fraud determination, so it would be inappropriate to assert that the claimed invention preempts the field or monopolizes the basic tools fraud determination. In other words, the disclosure will not prevent others from analyzing transactions for fraud, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber (e.g., a user, consumer, etc.) when their computer is offline. The system may include generating customized information and alerting a remote subscriber that the transaction and/or identifier information can be accessed from their computer. The alerts are generated by filtering received information, building information alerts and formatting the alerts into data blocks based upon subscriber preference information. The data blocks are transmitted to the subscriber's web client 120 which, when connected to a computer, causes the computer to auto-launch an application to display the information alert and provide access to more detailed information about the information alert, which may indicate whether a transaction was approved or rejected by authorization system 140. More particularly, the method may comprise providing a viewer application to a subscriber for installation on a remote subscriber computer and/or web client 120; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generating an information alert from the filtered information that contains a name, a price and a universal resource locator (URL), which specifies the location of the data source; formatting the information alert into data blocks according to said information format; and transmitting the formatted information alert over a wireless communication channel to web client 120 associated with the consumer based upon the destination address and transmission schedule, wherein the alert activates the application to cause the information alert to display on the remote subscriber computer and/or web client 120 and to enable connection via the URL to the data source over the Internet when web client 120 is locally connected to the remote subscriber computer and the remote subscriber computer comes online.

In various embodiments, the system and method may include a graphical user interface (i.e., comprised in web client 120) for dynamically relocating/rescaling obscured textual information of an underlying window to become automatically viewable to the user. Such textual information may be comprised in merchant system 130 and/or any other interface presented to the consumer or user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen (comprised in web client 120, for example); displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email, messages within merchant system 130) to prevent a computer, server, and/or system from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over consumers during affiliate purchase transactions, using a system for co-marketing the “look and feel” of the host web page (e.g., a web page from merchant system 130) with the product-related content information of the advertising merchant's web page. The system can be operated by a third-party outsource provider, who acts as a broker between multiple hosts and merchants. Prior to implementation, a host places links to a merchant's server on the host's web page (e.g., a web page from merchant system 130). The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A consumer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the consumer as associated with the host web page. The server then transmits and presents this composite web page to the consumer so that she effectively remains on the host web page to purchase the item without being redirected to the third party merchant affiliate. Because such composite pages are visually perceived by the consumer as associated with the host web page, they give the consumer the impression that she is viewing pages served by the host. Further, the consumer is able to purchase the item without being redirected to the third party merchant affiliate, thus allowing the host to retain control over the consumer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all Alexa-enabled devices.

The phrases consumer, customer, user, account holder, account affiliate, cardmember or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction information/details. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

Practitioners will appreciate that web client 120 may or may not be in direct contact with an application server. For example, web client 120 may access the services of an application server through another server and/or hardware component, which may have a direct or indirect connection to an Internet server. For example, web client 120 may communicate with an application server via a load balancer. In various embodiments, access is through a network or the Internet through a commercially-available web-browser software package.

As those skilled in the art will appreciate, web client 120 may include an operating system (e.g., WINDOWS®/CE/Mobile, OS2, UNIX®, LINUX®, SOLARIS®, MacOS, etc.) as well as various conventional support software and drivers typically associated with computers. Web client 120 may include any suitable personal computer, network computer, workstation, personal digital assistant, cellular phone, smart phone, minicomputer, mainframe or the like. Web client 120 can be in a home or business environment with access to a network. In various embodiments, access is through a network or the Internet through a commercially available web-browser software package. Web client 120 may implement security protocols such as Secure Sockets Layer (SSL) and Transport Layer Security (TLS). Web client 120 may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of web client 120 may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a My SQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user,” “consumer,” “customer,” “cardmember,” “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to a “party” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account,” “account number,” “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000.” The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a processor, a transaction authorization request for a transaction comprising transaction details;
inputting, by the processor, the transaction details into a fraud scoring system comprising a fixed fraud detection model;
inputting, by the processor, the transaction details into a neural network comprising an improvable fraud detection model;
applying, by the processor and via the fraud scoring system, the fixed fraud detection model to the transaction details;
producing, by the processor and via the fraud scoring system, a fraud score in response to the applying the fixed fraud detection model to the transaction details;
applying, by the processor and via the neural network, the improvable fraud detection model to the transaction details;
producing, by the processor and via the neural network, a neural network fraud score in response to the applying the improvable fraud detection model to the transaction details;
analyzing, by the processor, the fraud score and the neural network fraud score; and
sending, by the processor, an authorization response in response to the analyzing the fraud score and the neural network fraud score.

2. The method of claim 1, wherein the analyzing the fraud score and the neural network fraud score comprises combining, by the processor, the fraud score and the neural network fraud score to produce a fraud prediction score; and
analyzing, by the processor, the fraud prediction score.

3. The method of claim 1, wherein, one of before the receiving the transaction details or after the sending the authorization response, the method further comprises updating, by the processor, the improvable fraud detection model, wherein the neural network utilizes normalized adaptive gradient updates for the updating.

4. The method of claim 3, wherein the updating improvable fraud detection model comprises:
receiving, by the processor, new transaction information for a plurality of new transactions, wherein the plurality of new transactions comprises a plurality of new approved transactions comprising new approved transaction details and a plurality of new fraudulent transactions comprising new fraudulent transaction details;
automatically inputting, by the processor, the new transaction information into the neural network;
automatically inputting, by the processor, a plurality of desired neural network outputs into the neural network each associated with at least one new transaction of the plurality of new transactions;
automatically applying, by the processor, the improvable fraud detection model of the neural network to each new transaction of the plurality of new transactions, producing, by the processor, a training neural network fraud score associated with each new transaction of the plurality of new transactions;
comparing, by the processor, the training neural network fraud score associated with each new transaction of the plurality of new transactions with the desired neural network output of each respective new transaction of the plurality of new transactions;
calculating, by the processor, a first calculated score difference between the training neural network fraud score and the desired neural network output in response to the comparing the training neural network fraud score with the desired neural network output;
adjusting, by the processor, the improvable fraud detection model based on the first calculated score difference, producing, by the processor, an updated improvable fraud detection model; and
replacing, by the processor, the improvable fraud detection model in the neural network with the updated improvable fraud detection model.

5. The method of claim 4, wherein the adjusting the improvable fraud detection model to produce the updated improvable fraud detection model comprises adjusting a plurality of weighted parameters comprised in the improvable fraud detection model.

6. The method of claim 1, wherein the combining the fraud score and the neural network fraud score comprises:
converting, by the processor, the fraud score to a first probability by applying a probability mapping function to the fraud score;
converting, by the processor, the neural network fraud score to a second probability by applying a probability mapping function to the neural network fraud score; and
adding, by the processor, the first probability and the second probability together to produce the fraud prediction score.

7. The method of claim 6, wherein the adding the first probability and the second probability together comprises:
applying, by the processor, a first probability weight to the first probability producing a first adjusted probability;
applying, by the processor, a second probability weight to the second probability producing a second adjusted probability; and
adding the first adjusted probability and the second adjusted probability together,
wherein a sum of the first probability weight and the second probability weight is 1.

8. The method of claim 1, wherein the analyzing the fraud prediction score comprises determining if the fraud prediction score is above a predetermined fraud detection score threshold,
wherein, in response to the fraud prediction score being one of above or below the predetermined fraud detection score threshold, the sending an authorization response comprises denying, by the processor, the transaction request, and
wherein, in response to the fraud prediction score being one of below or above the predetermined fraud detection score threshold, the sending an authorization response comprises approving, by the processor, the transaction request.

9. An article of manufacture including a non-transitory, tangible computer readable memory having instructions stored thereon that, in response to execution by a processor, cause the processor to perform operations comprising:
receiving, by the processor, a transaction authorization request for a transaction comprising transaction details;
inputting, by the processor, the transaction details into a fraud scoring system comprising a fixed fraud detection model;
inputting, by the processor, the transaction details into a neural network comprising an improvable fraud detection model;
applying, by the processor and via the fraud scoring system, the fixed fraud detection model to the transaction details;
producing, by the processor and via the fraud scoring system, a fraud score in response to the applying the fixed fraud detection model to the transaction details;
applying, by the processor and via the neural network, the improvable fraud detection model to the transaction details;
producing, by the processor and via the neural network, a neural network fraud score in response to the applying the improvable fraud detection model to the transaction details;
analyzing, by the processor, the fraud score and the neural network fraud score; and
sending, by the processor, an authorization response in response to the analyzing the fraud score and the neural network fraud score.

10. The article of claim 9, wherein the analyzing the fraud score and the neural network fraud score comprises combining, by the processor, the fraud score and the neural network fraud score to produce a fraud prediction score; and
analyzing, by the processor, the fraud prediction score.

11. The article of claim 9, wherein, one of before the receiving the transaction details or after the sending the authorization response, the operations further comprise updating, by the processor, the improvable fraud detection model.

12. The article of claim 11, wherein the updating improvable fraud detection model comprises:
receiving, by the processor, new transaction information for a plurality of new transactions, wherein the plurality of new transactions comprises a plurality of new approved transactions comprising new approved transaction details and a plurality of new fraudulent transactions comprising new fraudulent transaction details;
automatically inputting, by the processor, the new transaction information into the neural network;
automatically inputting, by the processor, a plurality of desired neural network outputs into the neural network each associated with at least one new transaction of the plurality of new transactions;
automatically applying, by the processor, the improvable fraud detection model of the neural network to each new transaction of the plurality of new transactions, producing, by the processor, a training neural network fraud score associated with each new transaction of the plurality of new transactions;
comparing, by the processor, the training neural network fraud score associated with each new transaction of the plurality of new transactions with the desired neural network output of each respective new transaction of the plurality of new transactions;
calculating, by the processor, a first calculated score difference between the training neural network fraud score and the desired neural network output in response to the comparing the training neural network fraud score with the desired neural network output;
adjusting, by the processor, the improvable fraud detection model based on the first calculated score difference, producing, by the processor, an updated improvable fraud detection model; and
replacing, by the processor, the improvable fraud detection model in the neural network with the updated improvable fraud detection model.

13. The article of claim 12, wherein the adjusting the improvable fraud detection model to produce the updated improvable fraud detection model comprises adjusting a plurality of weighted parameters comprised in the improvable fraud detection model.

14. The article of claim 9, wherein the combining the fraud score and the neural network fraud score comprises:
converting, by the processor, the fraud score to a first probability by applying a probability mapping function to the fraud score;
converting, by the processor, the neural network fraud score to a second probability by applying a probability mapping function to the neural network fraud score; and
adding, by the processor, the first probability and the second probability together to produce the fraud prediction score.

15. The article of claim 14, wherein the adding the first probability and the second probability together comprises:
applying, by the processor, a first probability weight to the first probability producing a first adjusted probability;
applying, by the processor, a second probability weight to the second probability producing a second adjusted probability; and
adding the first adjusted probability and the second adjusted probability together,
wherein a sum of the first probability weight and the second probability weight is 1.

16. The article of claim 9, wherein the analyzing the fraud prediction score comprises determining if the fraud prediction score is above a predetermined fraud detection score threshold,
wherein, in response to the fraud prediction score being one of above or below the predetermined fraud detection score threshold, the sending an authorization response comprises denying, by the processor, the transaction request, and
wherein, in response to the fraud prediction score being one of below or above the predetermined fraud detection score threshold, the sending an authorization response comprises approving, by the processor, the transaction request.

17. A computer-based system comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, a transaction authorization request for a transaction comprising transaction details;
inputting, by the processor, the transaction details into a fraud scoring system comprising a fixed fraud detection model;
inputting, by the processor, the transaction details into a neural network comprising an improvable fraud detection model;
applying, by the processor and via the fraud scoring system, the fixed fraud detection model to the transaction details;
producing, by the processor and via the fraud scoring system, a fraud score in response to the applying the fixed fraud detection model to the transaction details;
applying, by the processor and via the neural network, the improvable fraud detection model to the transaction details;
producing, by the processor and via the neural network, a neural network fraud score in response to the applying the improvable fraud detection model to the transaction details;
analyzing, by the processor, the fraud score and the neural network fraud score; and
sending, by the processor, an authorization response in response to the analyzing the fraud score and the neural network fraud score.

18. The article of claim 17, wherein, one of before the receiving the transaction details or after the sending the authorization response, the operations further comprise updating, by the processor, the improvable fraud detection model, which comprises:
receiving, by the processor, new transaction information for a plurality of new transactions, wherein the plurality of new transactions comprises a plurality of new approved transactions comprising new approved transaction details and a plurality of new fraudulent transactions comprising new fraudulent transaction details;
automatically inputting, by the processor, the new transaction information into the neural network;
automatically inputting, by the processor, a plurality of desired neural network outputs into the neural network each associated with at least one new transaction of the plurality of new transactions;
automatically applying, by the processor, the improvable fraud detection model of the neural network to each new transaction of the plurality of new transactions, producing, by the processor, a training neural network fraud score associated with each new transaction of the plurality of new transactions;
comparing, by the processor, the training neural network fraud score associated with each new transaction of the plurality of new transactions with the desired neural network output of each respective new transaction of the plurality of new transactions;
calculating, by the processor, a first calculated score difference between the training neural network fraud score and the desired neural network output in response to the comparing the training neural network fraud score with the desired neural network output;
adjusting, by the processor, the improvable fraud detection model based on the first calculated score difference, producing, by the processor, an updated improvable fraud detection model; and
replacing, by the processor, the improvable fraud detection model in the neural network with the updated improvable fraud detection model.

19. The article of claim 17, wherein the combining the fraud score and the neural network fraud score comprises:
converting, by the processor, the fraud score to a first probability by applying a probability mapping function to the fraud score;
converting, by the processor, the neural network fraud score to a second probability by applying a probability mapping function to the neural network fraud score; and
adding, by the processor, the first probability and the second probability together to produce the fraud prediction score.

20. The article of claim 17, wherein the analyzing the fraud prediction score comprises determining if the fraud prediction score is above a predetermined fraud detection score threshold,
wherein, in response to the fraud prediction score being one of above or below the predetermined fraud detection score threshold, the sending an authorization response comprises denying, by the processor, the transaction request, and
wherein, in response to the fraud prediction score being one of below or above the predetermined fraud detection score threshold, the sending an authorization response comprises approving, by the processor, the transaction request.
